(19) United States
(12) Patent Application Publication
(10) Pub. No.: US 2025/0360406 A1
(43) Pub. Date: Nov. 27, 2025

(54) METHOD AND APPARATUS FOR OBTAINING VIRTUAL CHARACTER, STORAGE MEDIUM, AND ELECTRONIC DEVICE

(71) Applicant: Tencent Technology (Shenzhen) Company Limited, Shenzhen (CN)

(72) Inventor: Ziqi WEI, Shenzhen (CN)

(21) Appl. No.: 19/298,113

(22) Filed: Aug. 12, 2025

Related U.S. Application Data
(63) Continuation of application No. PCT/CN2024/098370, filed on Jun. 11, 2024.

(30) Foreign Application Priority Data
Jul. 28, 2023 (CN) 202310952100.3

(51) Int. Cl. A63F 13/525

(52) U.S. Cl. CPC A63F 13/525

(57) ABSTRACT

A method for obtaining a virtual character in a game is performed by an electronic device. The method includes: in response to a lock operation on a first virtual character deployed by a user account in the current game, setting a state of the first virtual character to a locked state; when a virtual card display window is refreshed, displaying a plurality of virtual cards in the virtual card display window, each virtual card configured for determining a corresponding virtual character as the virtual character deployed by the user account in the current game; and when a first virtual card corresponding to the first virtual character exists in the plurality of virtual cards, setting the virtual card display window to a refresh-disabled state. The technical problem of low efficiency in obtaining the virtual character in the related art is resolved.

### CROSS-REFERENCE TO RELATED APPLICATIONS

This application is a continuation application of PCT Patent Application No. PCT/CN2024/098370, entitled “METHOD AND APPARATUS FOR OBTAINING VIRTUAL CHARACTER, STORAGE MEDIUM, AND ELECTRONIC DEVICE” filed on Jun. 11, 2024, which claims priority to Chinese Patent Application No. 202310952100.3, entitled “METHOD AND APPARATUS FOR OBTAINING VIRTUAL CHARACTER, STORAGE MEDIUM, AND ELECTRONIC DEVICE” filed with the China National Intellectual Property Administration on Jul. 28, 2023, both of which are incorporated by reference in their entirety.

### FIELD OF THE TECHNOLOGY

This application relates to the field of computers, and specifically, to a technology for obtaining a virtual character.

### BACKGROUND OF THE DISCLOSURE

In the related field of gaming, game modes in which virtual characters in games serve as pieces and players conduct matches by placing the pieces in a battle zone are collectively referred to as an auto chess game.

During a game preparation phase, players select virtual cards in a virtual card display window to obtain virtual characters corresponding to the virtual cards, and deploy the virtual characters in the battle zone to engage in a game. Since different virtual characters have different attributes and skills, and various combinations of virtual characters form different game lineups, players' selection and deployment of virtual characters is the key to determining victory or defeat.

In the related art, the game preparation phase has limited time, and players need to quickly refresh the virtual cards in the virtual card display window within a specified preparation time to find needed virtual characters. However, overly quick refreshing may cause players to accidentally skip a virtual card corresponding to a needed virtual character, reducing the gaming experience.

For the foregoing problem, no effective solution has been provided at present.

### SUMMARY

Embodiments of this application provide a method and an apparatus for obtaining a virtual character, a storage medium, and an electronic device, to resolve at least a technical problem of low efficiency in obtaining a virtual character in the related art.

According to one aspect of the embodiments of this application, a method for obtaining a virtual character in a game is performed by an electronic device and the method includes: during a preparation phase of a current game, in response to a lock operation on a first virtual character deployed by a user account in the current game, setting a state of the first virtual character to a locked state; when a virtual card display window of the current game is refreshed, displaying a plurality of virtual cards in the virtual card display window, each of the plurality of virtual cards being configured for determining, when obtained by the user account, a corresponding virtual character as the virtual character deployed by the user account in the current game; and when a first virtual card corresponding to the first virtual character that is in the locked state exists in the plurality of virtual cards, setting the virtual card display window to a refresh-disabled state, and the refresh-disabled state being configured for keeping the plurality of virtual cards displayed in the virtual card display window unchanged when the virtual card display window is refreshed.

According to still another aspect of the embodiments of this application, a non-transitory computer-readable storage medium is further provided. The computer-readable storage medium has a computer program stored therein, the computer program, when executed by a processor of an electronic device, causing the electronic device to perform the foregoing method for obtaining a virtual character during running.

According to still another aspect of the embodiments of this application, an electronic device is further provided. The electronic device includes a memory and a processor, the memory having a computer program stored therein, and the processor being configured to perform the foregoing method for obtaining a virtual character through the execution of the computer program.

In the embodiments of this application, in the preparation phase of the game, the user account locks the first virtual character. If the first virtual card corresponding to the first virtual character exists in the virtual cards that need to be displayed when the virtual card display window is refreshed, the virtual card display window is set to the refresh-disabled state, so that the virtual cards displayed in the virtual card display window remain unchanged when the virtual card display window is refreshed. This prevents the user account from accidentally skipping the needed first virtual card corresponding to the first virtual character. Therefore, the user account can quickly find the first virtual card corresponding to the first virtual character in the virtual card display window, thereby achieving the technical effect of improving the efficiency in obtaining a virtual character, and further resolving the technical problem of low efficiency in obtaining the virtual character in the related art.

### BRIEF DESCRIPTION OF THE DRAWINGS

The accompanying drawings herein are configured for providing a further understanding of this application and constitute a part of this application. Example embodiments of this application and the descriptions thereof are intended to explain this application, and do not constitute any limitation on this application. In the accompanying drawings:

FIG. 1 is a schematic diagram of an application environment of a method for obtaining a virtual character according to an embodiment of this application.

FIG. 2 is a schematic flowchart of a method for obtaining a virtual character according to an embodiment of this application.

FIG. 3 is a schematic diagram of a game picture according to an embodiment of this application.

FIG. 4 is a schematic diagram of another game picture according to an embodiment of this application.

FIG. 5 is a schematic diagram of another game picture according to an embodiment of this application.

FIG. 6 is a schematic diagram of another game picture according to an embodiment of this application.

FIG. 7 is a schematic diagram of another game picture according to an embodiment of this application.

FIG. 8 is a schematic diagram of another game picture according to an embodiment of this application.

FIG. 9 is a schematic diagram of another game picture according to an embodiment of this application.

FIG. 10 is a schematic diagram of another game picture according to an embodiment of this application.

FIG. 11 is a schematic diagram of another game picture according to an embodiment of this application.

FIG. 12 is a schematic diagram of another game picture according to an embodiment of this application.

FIG. 13 is a schematic diagram of another game picture according to an embodiment of this application.

FIG. 14 is a schematic diagram of another game picture according to an embodiment of this application.

FIG. 15 is a schematic diagram of another game picture according to an embodiment of this application.

FIG. 16 is a schematic flowchart according to an embodiment of this application.

FIG. 17 is another schematic flowchart according to an embodiment of this application.

FIG. 18 is another schematic flowchart according to an embodiment of this application.

FIG. 19 is a schematic structural diagram of an apparatus for obtaining a virtual character according to an embodiment of this application.

FIG. 20 is a structural block diagram of a computer system of an electronic device according to an embodiment of this application.

FIG. 21 is a schematic structural diagram of an electronic device according to an embodiment of this application.

### DESCRIPTION OF EMBODIMENTS

To enable a person in the art to better understand the solution of this application, the following clearly and completely describes the technical solutions in the embodiments of this application with reference to the accompanying drawings in the embodiments of this application. Apparently, the described embodiments are only some of the embodiments of this application rather than all of the embodiments. Based on embodiments of this application, all other embodiments obtained by a person of ordinary skill in the art without creative efforts fall within the protection scope of this application.

The specification, claims, and terms “first” and “second” of the foregoing accompanying drawings of this application are used to distinguish similar objects, but are unnecessarily used to describe a specific sequence or order. The data used in such a way is interchangeable in proper circumstances, so that the embodiments of this application described herein can be implemented in other sequences than the sequence illustrated or described herein. Moreover, the terms “comprise”, “include”, and any other variants thereof mean to cover the non-exclusive inclusion. For example, a process, method, system, product, or device that includes a list of operations or units is not necessarily limited to those operations or units that are clearly listed, but may include other operations or units not expressly listed or inherent to such a process, method, system, product, or device.

First, some terms or expressions appearing in the description of the embodiments of this application are defined as follows.

An auto chess is a general term fora category of electronic strategy board games. Its basic game rules involve players selecting and combining pieces from different types, and then deploying the pieces on their own chessboards. Finally, the system automatically engages the pieces in battles against other players' pieces until only one player has surviving pieces and is declared the winner, and the losers lose health points. This process is repeated for a plurality of times until only one of a plurality of players survives.

This application is described below with reference to the embodiments.

According to an aspect of the embodiments of this application, a method for obtaining a virtual character is provided. In this embodiment, the method for obtaining a virtual character may be applied to a hardware environment including a server 101 and a terminal device 103 shown in FIG. 1. As shown in FIG. 1, the server 101 is connected to the terminal 103 through a network, and may be configured for providing a service to the terminal device or an application installed on the terminal device. The application may be a video application, an instant messaging application, a browser application, an education application, a game application, or the like. A database 105 may be disposed on the server or independent of the server, and is configured to provide a data storage service to the server 101, for example, a game data storage server. The network may include, but is not limited to, a wired network and a wireless network. The wired network includes a local area network, a metropolitan area network, and a wide area network. The wireless network includes Bluetooth, Wi-Fi, and other networks that implement wireless communication. The terminal device 103 may be a terminal configured with a game application, and may include, but is not limited to, at least one of the following: a computer device such as a mobile phone (for example, an Android mobile phone or an iOS mobile phone), a notebook computer, a tablet computer, a palmtop computer, a mobile Internet device (MID), a PAD, a desktop computer, or a smart television. The server may be a single server, or may be a server cluster including a plurality of servers, or may be a cloud server, and may include, but is not limited to, a router or a gateway. A game application 107 using the foregoing method for obtaining a virtual character is displayed through the terminal device 103. A round of game may be played on the game application 107 through an entry of the game application 107 that is configured on the terminal to obtain a virtual character. A second account may play an online game with a first account through an entry of a game application 109.

With reference to FIG. 1, the foregoing method for obtaining a virtual character may be implemented by the terminal device 103 through the following operations.

S1: Set, in a preparation phase of a current game, in response to a lock operation on a first virtual character, a state of the first virtual character to a locked state, the first virtual character being a virtual character deployed by a user account in the current game.

S2: Display, when a virtual card display window is refreshed, a plurality of virtual cards in the virtual card display window, each virtual card corresponding to one virtual character, each of the plurality of virtual cards being configured for determining, when obtained by the user account, the corresponding virtual character as the virtual character deployed by the user account in the current game, if a first virtual card corresponding to the first virtual character that is in the locked state exists in the plurality of virtual cards, the virtual card display window being set to a refresh-disabled state, and the refresh-disabled state being configured for keeping the plurality of virtual cards displayed in the virtual card display window unchanged when the virtual card display window is refreshed.

In this embodiment, the method for obtaining a virtual character may alternatively be implemented by a server, for example, the server 101 shown in FIG. 1, or jointly implemented by a user terminal and a server.

The foregoing descriptions are merely an example, and are not specifically limited in this embodiment.

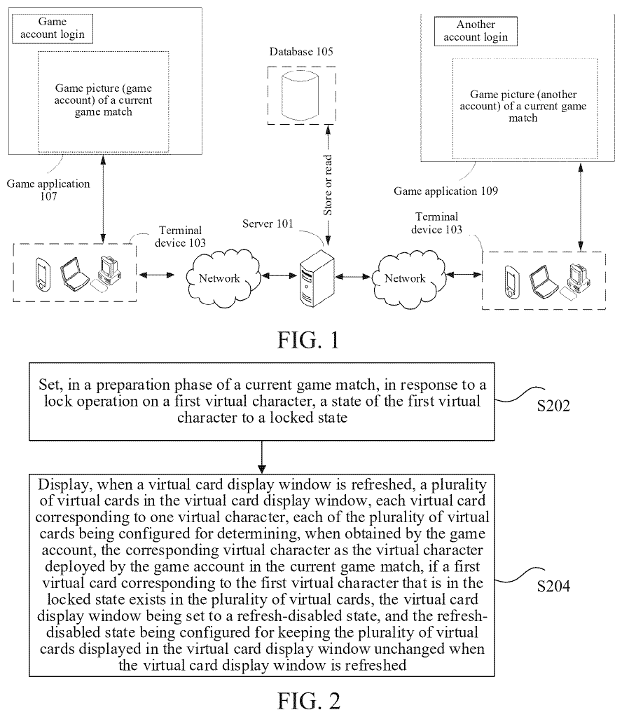

In some embodiments, in an implementation, as shown in FIG. 2, the foregoing method for obtaining a virtual character includes the following operations.

S202: Set, in a preparation phase of a current game, in response to a lock operation on a first virtual character, a state of the first virtual character to a locked state, the first virtual character being a virtual character deployed by a user account in the current game.

S204: Display, when a virtual card display window is refreshed, a plurality of virtual cards in the virtual card display window, each virtual card corresponding to one virtual character, each of the plurality of virtual cards being configured for determining, when obtained by the user account, the corresponding virtual character as the virtual character deployed by the user account in the current game, if a first virtual card corresponding to the first virtual character that is in the locked state exists in the plurality of virtual cards, the virtual card display window being set to a refresh-disabled state, and the refresh-disabled state being configured for keeping the plurality of virtual cards displayed in the virtual card display window unchanged when the virtual card display window is refreshed.

The following describes the gameplay of the current game.

A player logs in to a game client using a user account, and a game picture is displayed on the game client to which the user account is logged in. The game picture includes a preparation zone and a battle zone. The preparation zone is configured for placing virtual characters obtained by the user account. The user account may deploy the virtual characters in the preparation zone in the battle zone, and the virtual characters located in the battle zone may automatically search for virtual characters of another account (opponent) to battle.

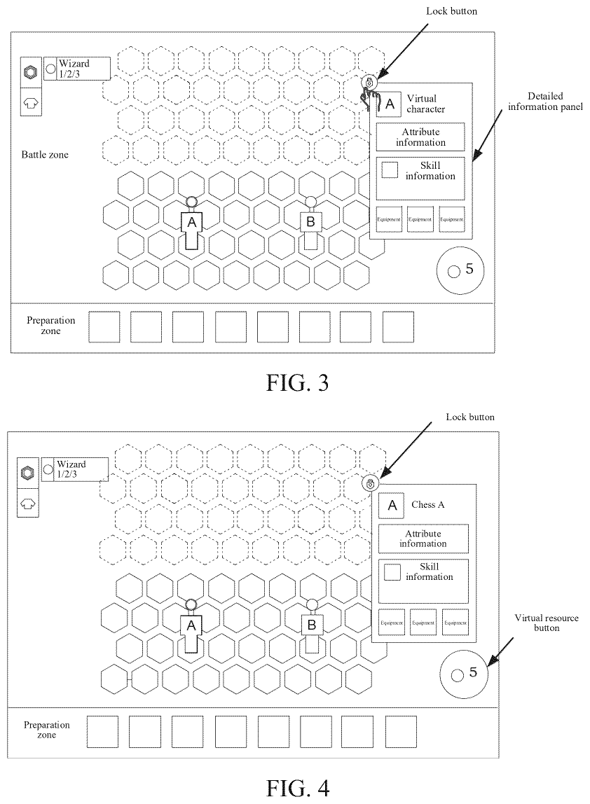

The first virtual character is a virtual character obtained by the user account, a virtual character located in the battle zone, or a virtual character located in the preparation zone. The lock operation may be an operation of locking the first virtual character deployed in the battle zone, thereby avoiding accidentally skipping the first virtual character deployed in the battle zone. For example, the lock operation may be triggering a lock button. The game picture shown in FIG. 3 is used as an example. The first virtual character is a virtual character A, and a trigger operation is performed on the virtual character A. The game picture displays a detailed information panel for the virtual character A, and the detailed information panel displays attribute information and skill information of the virtual character A. The detailed information panel for the virtual character A further displays a lock button. In this case, the lock button is in an unlocked state, indicating that the virtual character A is in a non-locked state. The trigger operation may be an operation of triggering the display of the detailed information panel for the virtual character, for example, may be clicking to select the first virtual character, or performing a slide operation on the first virtual character.

If the lock operation is performed on the virtual character A, the virtual character A may be locked in response to the user account performing the lock operation (for example, clicking the lock button) on the virtual character A. When the virtual character A is in the locked state, the lock button is displayed to the locked state. A lock button shown in FIG. 4 is in the locked state.

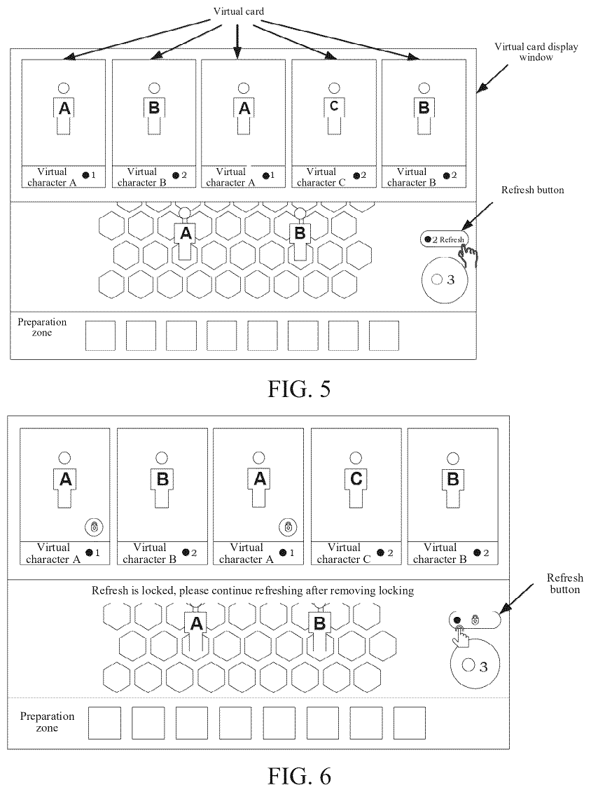

A trigger operation performed by the user account on a virtual resource button shown in FIG. 4 is obtained, and the virtual card display window shown in FIG. 5 is displayed. The virtual card display window may be refreshed, and when each round of the game starts, the game automatically refreshes virtual cards in the virtual card display window. The user account may also spend a preset quantity of virtual resources to refresh the virtual cards in the virtual card display window. For example, a trigger operation performed by the user account on a refresh button shown in FIG. 5 is obtained, virtual characters in the virtual card display window are refreshed, and in response to the trigger operation performed by the user account on the refresh button, the preset quantity of virtual resources are deducted from the user account. The preset quantity of virtual resources may be set according to an actual situation. For example, a refresh operation shown in FIG. 5 requires deducting two virtual resources (for example, two gold coins) from the user account.

A plurality of virtual cards: a virtual card A, a virtual card B, and a virtual card C are displayed in the virtual card display window displayed in the game picture in FIG. 5. Each card corresponds to one virtual character. An obtaining operation performed by the user account on the virtual card is obtained, to obtain the virtual character corresponding to the virtual card. For example, in response to an obtaining operation performed by the user account on the virtual card corresponding to the virtual character A (for example, clicking to select the virtual card corresponding to the virtual character A), the user account obtains the virtual character A, and the obtained virtual character A may be displayed in the preparation zone.

An example in which the first virtual character is the virtual character A is used. If the virtual card corresponding to the virtual character A exists in the virtual card display window shown in FIG. 5, the virtual card display window is set to the refresh-disabled state.

Target prompt information is displayed in response to the refresh operation of the user account when the virtual card display window is in the refresh-disabled state. The target prompt information being configured for prompting that the virtual card display window is in the refresh-disabled state, and the plurality of virtual cards displayed in the virtual card display window remain unchanged. For example, when the virtual card display window is in the refresh-disabled state, the trigger operation performed by the user account on the refresh button shown in FIG. 6 (for example, clicking the refresh button) is obtained, and the target prompt information “Refresh is locked. Please unlock to continue” shown in FIG. 6 is displayed. The virtual cards in the virtual card display window remain unchanged. The refresh button is in the locked state, preventing the virtual cards in the virtual card display window from being refreshed.

An unlocking manner includes, but is not limited to, the following several manners.

Manner 1: When the plurality of virtual cards are displayed in the virtual card display window, if the first virtual card exists in the plurality of virtual cards displayed in the virtual card display window, the plurality of virtual cards are displayed in the virtual card display window, and a lock icon is displayed on the first virtual card. Then, if the trigger operation is performed on the lock icon, the locked state of the first virtual character may be removed in response to the trigger operation on the lock icon displayed on the first virtual card.

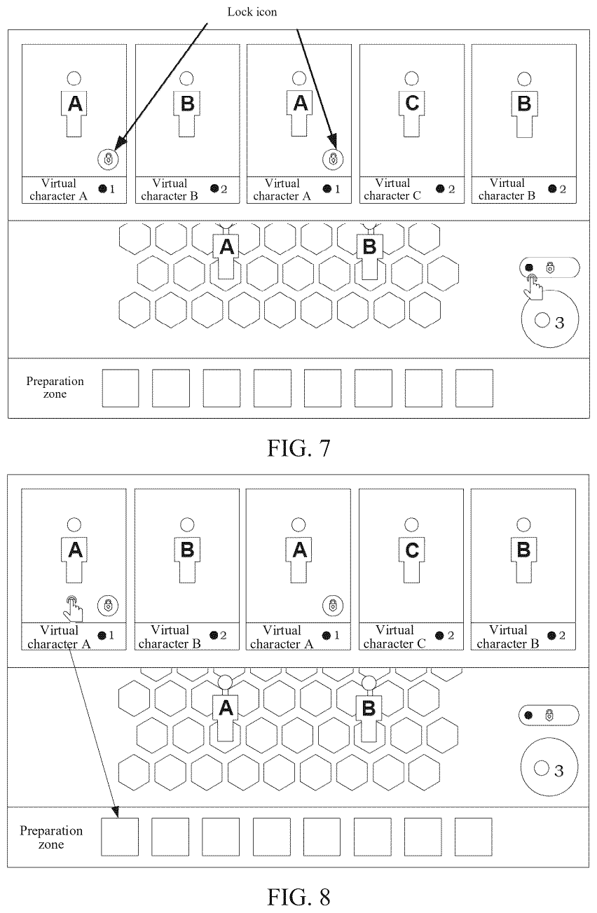

For example, the first virtual character is the virtual character A. The virtual card corresponding to the virtual character A exists in the virtual card display window shown in FIG. 7, the lock icon is displayed on the virtual card corresponding to the virtual character A. A trigger operation performed by the user account on the lock icon displayed on the virtual card corresponding to the virtual character A is obtained, and the locked state of the virtual character A is removed in response to the trigger operation.

Manner 2: The locked state of the first virtual character is removed in response to an obtaining operation on the first virtual card.

The obtaining operation performed by the user account on the virtual card (for example, clicking the virtual card) is obtained, and the user account obtains the virtual character corresponding to the virtual card. As shown in FIG. 8, the user account clicks the virtual card corresponding to the virtual character A, and performs the obtaining operation on the virtual character A. In response to the obtaining operation performed by the user account on the virtual card corresponding to the virtual character A, the virtual character A is displayed in the preparation zone, and the locked state of the virtual character A is removed. In this embodiment, if a plurality of virtual cards A exist in the virtual card display window, an obtaining operation performed by the user account on any virtual card A may remove the locked state of the virtual character A.

Manner 3: When N first virtual cards exist in the virtual card display window, the locked state of the first virtual character is removed in response to an obtaining operation on an N^{th} first virtual card, N being an integer greater than 1, and the N^{th} first virtual card being the last obtained virtual card of the N first virtual cards.

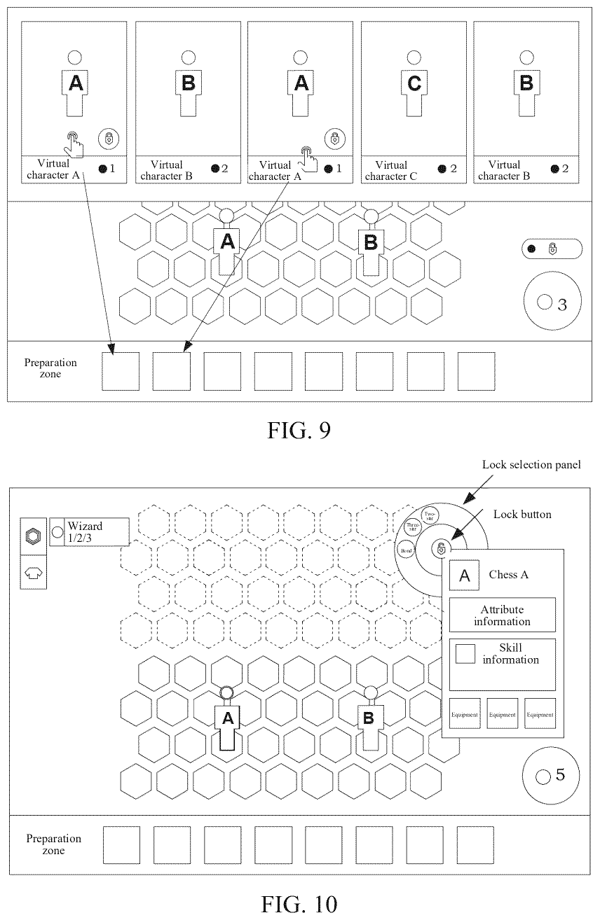

Manner 3 is similar to the foregoing manner 2, except that when a plurality of virtual cards corresponding to the virtual character A exist in the virtual card display window, the user account needs to obtain all the virtual cards corresponding to the virtual character A to remove the locked state of the virtual character A. An example in which N=2 shown in FIG. 9 is used. If two virtual cards corresponding to the virtual character A exist in the virtual card display window, the user account needs to obtain all virtual cards corresponding to the virtual character A to remove the locked state of the virtual character A. When the last one virtual card corresponding to the virtual character A is obtained by the user account, the locked state of the virtual character A is removed.

In the game, the virtual characters may be divided into different levels, and a higher-level virtual character has a stronger battle capability. For the same type of virtual characters, a predetermined quantity (which may be set according to an actual situation) of virtual characters of the same level may be merged into a higher-level virtual character. For example, the virtual characters may be divided into three star levels: one-star, two-star, and three-star, three one-star virtual characters may be merged into one two-star virtual character, and three two-star virtual characters may be merged into one three-star virtual character.

This application further provides a manner for locking a level of a virtual character. In the preparation phase of the current game, in response to a lock operation on a specific level of the first virtual character, the state of the first virtual character is set to the locked state if the first virtual character has not been merged into a virtual character of the specific level. The plurality of virtual cards are displayed in the virtual card display window when the virtual card display window is refreshed, the virtual card display window being set to the refresh-disabled state if the first virtual card exists in the plurality of virtual cards displayed in the virtual card display window.

In this case, if the first virtual character needs to be deployed in the preparation zone, the obtaining operation may be performed on the first virtual card, so that the first virtual character is displayed in the preparation zone of the current game in response to the obtaining operation on the first virtual card, in a battle phase of the current game, the first virtual character in the preparation zone being allowed to be deployed by the user account in the battle zone to battle.

If a quantity of first virtual characters deployed by the user account in the current game reaches a first preset quantity, the first preset quantity of first virtual characters are merged into the virtual character of the specific level, a battle power of the virtual character being greater than a battle power of the first virtual character, and the first virtual character deployed by the user account including the first virtual character deployed in the preparation zone and the first virtual character deployed in the battle zone; and the locked state of the first virtual character is removed.

An example in which the first virtual character in the foregoing embodiment is the virtual character A is used. In response to a long-press operation performed by the user account on the lock button shown in FIG. 10, a lock selection panel is triggered. The lock selection panel displays lock trigger buttons of different levels, for example, a two-star lock button and a three-star lock button shown in FIG. 10. The user account may select the two-star level or the three-star level as the specific level for locking according to an actual situation. Locking at different levels is mutually exclusive and cannot be selected simultaneously. In other words, the player can only choose one of the two-star level or the three-star level shown in FIG. 10 for locking.

An example in which the two-star level is used as the specific level for locking is used. If the virtual character A is at one-star level, three one-star virtual characters A may be merged into one two-star virtual character.

A lock operation performed by the user account on the two-star lock button (for example, clicking the two-star lock button) is obtained, the two-star virtual character A is locked in response to the lock operation, and the first virtual character is set to the locked state.

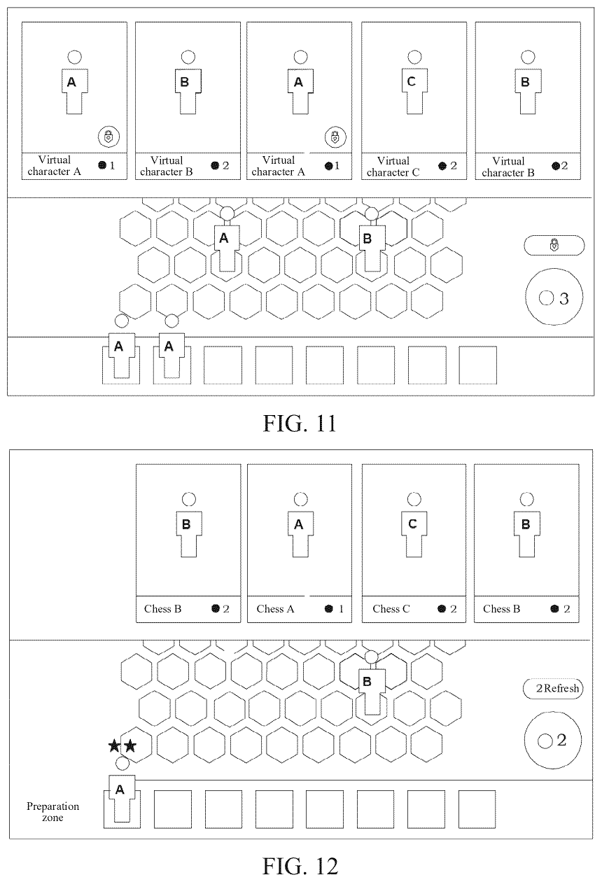

When the virtual card display window is refreshed, the virtual cards corresponding to the plurality of virtual characters are displayed in the virtual card display window. For example, the virtual cards corresponding to the virtual character A, the virtual character B, and the virtual character C are displayed in the virtual card display window shown in FIG. 11.

The user account clicks the virtual card to obtain the virtual character corresponding to the virtual card. FIG. 11 is used as an example. When the user account performs the obtaining operation on the virtual card A, the virtual character A obtained by the user account is displayed in the preparation zone of the user account.

As shown in FIG. 11, one virtual character A exists in the battle zone of the user account, two virtual characters A exist in the preparation zone, and the user account has three one-star virtual characters A, which reaches a first preset quantity of 3. Three one-star virtual characters A are merged into the two-star virtual character, and the locked state of the virtual character A is removed.

In the foregoing embodiments, the level of the virtual character A is locked, and the locked state of the virtual character A is removed when the level of the virtual character A reaches the two-star level. In this way, the player can quickly upgrade the virtual character.

In the game, each virtual character has its own unique bond type, and when several virtual characters with the same bond are deployed in the battle zone, the corresponding bond type may be activated, thereby improving the battle capability. This application further provides a manner of locking the bond type. Bond is a mechanism for enhancing the gaming experience by enriching character relationships and enriching emotional depth. It creates a strong connection between characters, providing players with a deeper and more engaging gaming experience. In game design, the bond can refer to a strong connection formed between virtual characters due to a certain relationship or experience. This connection may be based on various factors such as backstory, common goal, and adventure experience, and may have an important impact on gameplay and character development. This connection may be considered as a “relationship network” between characters, providing players with a deep gaming experience. For example, if a bond between two virtual characters is based on a relationship as a couple, when the two virtual characters are close to each other, a couple bond is triggered, granting shields to both characters.

In an implementation, in the preparation phase of the current game, in response to a lock operation on a specific bond of the first virtual character, a state of the specific bond is set to the locked state, a first battle attribute corresponding to the specific bond being activated when a quantity of specific bonds deployed by the user account in the current game reaches a second preset quantity; and the plurality of virtual cards are displayed in the virtual card display window when the virtual card display window is refreshed, each virtual card corresponding to one virtual character, each virtual character corresponding to one or more bonds, and if a virtual card corresponding to the virtual character having the specific bond exists in the plurality of virtual cards, the virtual card display window being set to the refresh-disabled state.

The lock selection panel shown in FIG. 10 further displays a bond lock button. A trigger operation performed by the user account on the bond lock button (for example, clicking the bond lock button) is obtained, and a specific bond of the virtual character A is locked in response to the trigger operation on the bond lock button.

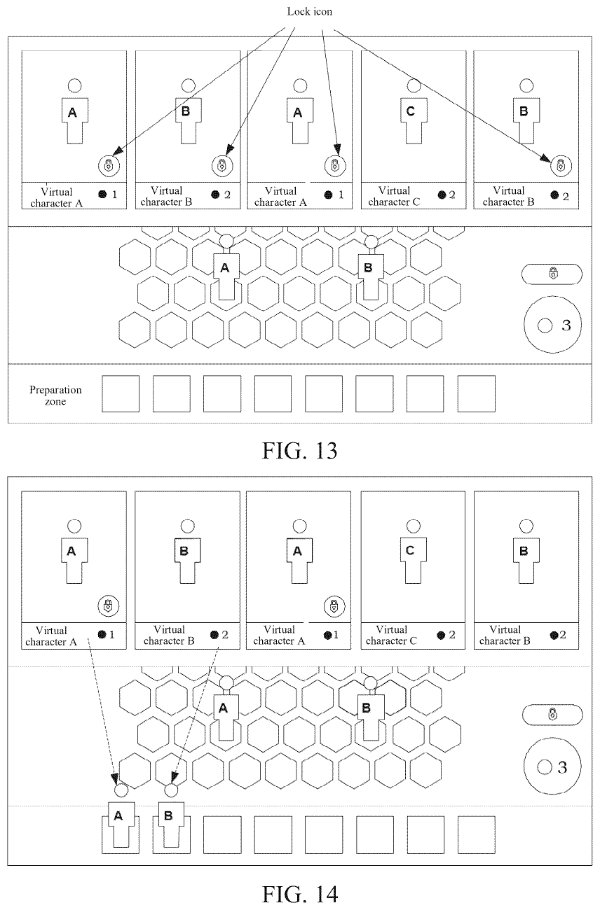

When the virtual card display window is refreshed, the plurality of virtual cards are displayed in the virtual card display window. The virtual card corresponding to the virtual character A, the virtual card corresponding to the virtual character B, and the virtual card corresponding to the virtual character C are displayed in the virtual card display window shown in FIG. 13. The virtual character A and the virtual character B have the same specific bond. lock icons are displayed on the virtual card corresponding to the virtual character A and the virtual card corresponding to the virtual character B. The lock icon is configured for indicating that the specific bond shared by the virtual character A and the virtual character B is locked.

The locked state of the specific bond may be removed in the following several manners.

Manner 1: When the plurality of virtual cards are displayed in the virtual card display window, if M virtual characters corresponding to M virtual cards of the plurality of virtual cards have the specific bond, the plurality of virtual cards are displayed in the virtual card display window, and the lock icons are displayed on the M virtual cards, M being an integer greater than or equal to 1. If the M virtual cards need to be unlocked, a trigger operation is performed on the lock icons on the M virtual cards, and the locked state of the specific bond is removed in response to the trigger operation on the lock icon displayed on any one of the M virtual cards.

For example, the lock icons are displayed on the virtual card A and the virtual card B shown in FIG. 13. The trigger operation performed by the user account on the lock icon on any virtual card is obtained, to remove the locked state of the specific bond.

Manner 2: If the virtual card corresponding to the virtual character having the specific bond exists in the virtual card display window, in response to an obtaining operation on the virtual card in the virtual card display window that corresponds to the virtual character having the specific bond, the locked state of the specific bond is removed.

For example, an obtaining operation performed by the user account on the virtual card (for example, clicking the virtual card) is obtained, and the user account obtains the virtual character corresponding to the virtual card in response to the obtaining operation. In a game picture shown in FIG. 13, the user account obtains a locked state in which the specific bond of any virtual character having the specific bond is removed. For example, in response to an obtaining operation performed by the user account on the virtual card corresponding to the virtual character A, the user account obtains the virtual character A, and the locked state of the specific bond is removed. Alternatively, in response to an obtaining operation performed by the user account on the virtual card corresponding to the virtual character B, the user account obtains the virtual character B, and the locked state of the specific bond is removed.

Manner 3: If K virtual characters corresponding to K virtual cards in the virtual card display window have the specific bond, in response to an obtaining operation on a K^{th} virtual card of the K virtual cards, the locked state of the specific bond is removed, the K^{th} virtual card being the last obtained virtual card of the K virtual cards.

For example, the user account obtains the corresponding virtual character by clicking the virtual card, and when obtaining the virtual character having the specific bond, the user account removes the locked state of the specific bond. In the game picture shown in FIG. 13, when obtaining all virtual cards corresponding to the virtual character A and the virtual character B, the user account removes the locked state of the specific bond.

In an implementation, in response to an obtaining operation on a second virtual card of the plurality of virtual cards that corresponds to a second virtual character having the specific bond, the second virtual character is displayed in the preparation zone of the current game, the second virtual character in the preparation zone being allowed to be deployed by the user account in the battle zone in the battle phase of the current game to battle.

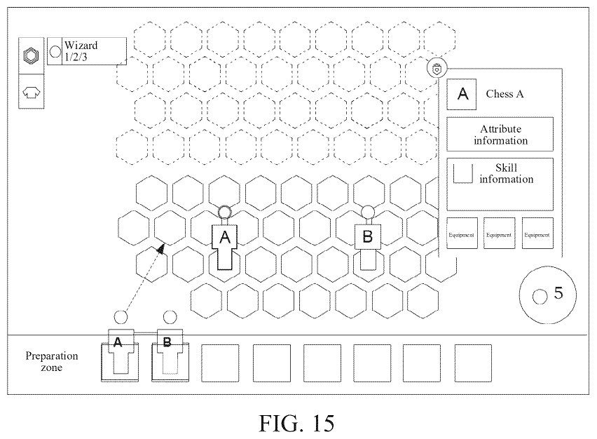

A game picture shown in FIG. 14 is used as an example. An obtaining operation performed by the user account on the virtual card A and the virtual card B is obtained, and the virtual character A and the virtual character B are displayed in the preparation zone. In response to a drag operation performed by the user account on the virtual character A and the virtual character B in the preparation zone, as shown in FIG. 15, the virtual character A and the virtual character B in the preparation zone are dragged to the battle zone to battle.

If S virtual characters deployed by the user account in the battle zone in the current game have the specific bond and a quantity of specific bonds reaches a second preset quantity, the first battle attribute of the S virtual characters is activated, S being an integer greater than or equal to 1.

The second preset quantity may be set according to an actual situation, and second preset quantities of different bond types may vary. An example in which the second preset quantity is three is used. In response to the drag operation performed by the user account on the virtual character A in the preparation zone, the virtual character A is displayed in the battle zone. Because the virtual character A and the virtual character B have the specific bonds, and the quantity of the specific bonds in the battle zone reaches the second preset quantity, first battle attributes of the virtual character A and the virtual character B located in the battle zone are activated. The first battle attribute includes, but is not limited to, increasing health points of the virtual character, increasing a battle power of the virtual character, or the like.

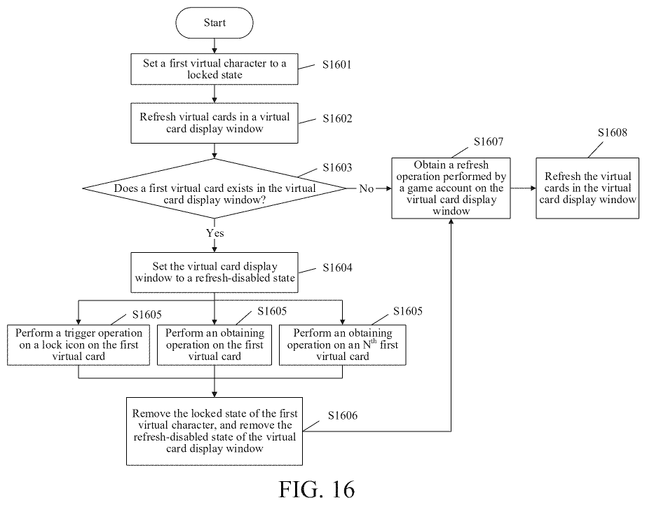

FIG. 16 is a flowchart of locking a first virtual character, including the following operations.

S1601: Obtain a lock operation performed by a user account on a first virtual character, and set the first virtual character to a locked state.

S1602: Refresh virtual cards in a virtual card display window, and display a plurality of virtual cards in the virtual card display window, each virtual card corresponding to one virtual character.

S1603: Determine, when the virtual card display window is refreshed, whether a first virtual card corresponding to the first virtual character exists in the virtual card display window, if the first virtual card corresponding to the first virtual character exists in the virtual card display window, perform S1604, and if the first virtual card corresponding to the first virtual character does not exist in the virtual card display window, perform S1607.

S1604: Set the virtual card display window to a refresh-disabled state, the plurality of virtual cards displayed in the virtual card display window remaining unchanged in the refresh-disabled state.

S1605: Remove the locked state of the first virtual character, which may be performed in one of the following manners: performing a trigger operation on a lock icon on the first virtual card in the virtual card display window, for example, clicking the lock icon; performing an obtaining operation on the first virtual card, for example, clicking to select the first virtual card; or if N first virtual cards exist in the virtual cards, performing the obtaining operation on the N virtual cards.

S1606: Remove the locked state of the first virtual character, and remove the refresh-disabled state of the virtual card display window.

S1607: Obtain a refresh operation performed by the user account on the virtual card display window.

S1608: Refresh the virtual cards in the virtual card display window.

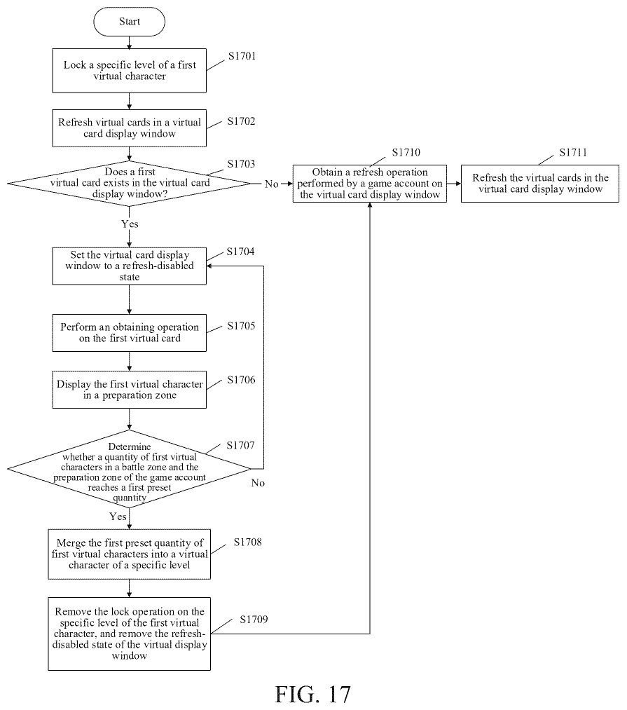

FIG. 17 is a flowchart of locking a specific level of a first virtual character, including the following operations.

S1701: Obtain a lock operation performed by a user account on a specific level of a first virtual character, and set the first virtual character to a locked state.

S1702: Refresh virtual cards in a virtual card display window, and display a plurality of virtual cards in the virtual card display window, each virtual card corresponding to one virtual character.

S1703: Determine, when the virtual card display window is refreshed, whether a first virtual card corresponding to the first virtual character exists in the virtual card display window, if the first virtual card corresponding to the first virtual character exists in the virtual card display window, perform S1704, and if the first virtual card corresponding to the first virtual character does not exist in the virtual card display window, perform S1710.

S1704: Set the virtual card display window to a refresh-disabled state, the plurality of virtual cards displayed in the virtual card display window remaining unchanged in the refresh-disabled state.

S1705: The user account performs an obtaining operation on the first virtual card.

S1706: Display the first virtual character in a preparation zone in response to the obtaining operation on the first virtual card.

S1707: Determine whether a quantity of first virtual characters in a battle zone and the preparation zone of the user account reaches a first preset quantity, if the quantity of first virtual characters reaches the first preset quantity, perform S1708, and if the quantity of first virtual characters does not reach the first preset quantity, perform S1704.

S1708: Merge the first preset quantity of first virtual characters into a virtual character of a specific level.

S1709: Remove the lock operation on the specific level of the first virtual character, and remove the refresh-disabled state of the virtual card display window.

S1710: Obtain a refresh operation performed by the user account on the virtual card display window.

S1711: Refresh the virtual cards in the virtual card display window.

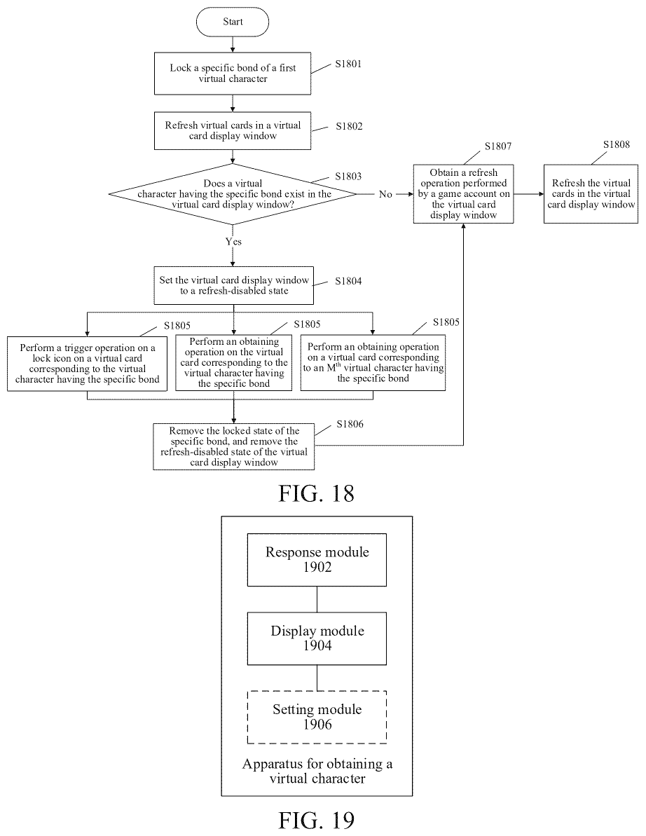

FIG. 18 is a flowchart of locking a specific bond of a first virtual character, including the following operations.

S1801: Obtain a lock operation performed by a user account on a specific bond of a first virtual character, and set the specific bond to a locked state.

S1802: Refresh virtual cards in a virtual card display window, and display a plurality of virtual cards in the virtual card display window, each virtual card corresponding to one virtual character.

S1803: Determine, when the virtual card display window is refreshed, whether a virtual character having the specific bond exists in the virtual card display window, if the virtual character having the specific bond exists in the virtual card display window, perform S1804, and if the virtual character having the specific bond does not exist in the virtual card display window, perform S1807.

S1804: Set the virtual card display window to a refresh-disabled state, the plurality of virtual cards displayed in the virtual card display window remaining unchanged in the refresh-disabled state.

S1805: Remove the locked state of the specific bond, which may be performed in one of the following manners: performing a trigger operation on a lock icon on the virtual card in the virtual card display window that corresponds to the virtual character having the specific bond, for example, clicking the lock icon; performing an obtaining operation on the virtual card corresponding to the virtual character having the specific bond, for example, clicking to select the virtual card corresponding to the virtual character having the specific bond; or performing, if virtual cards corresponding to M virtual characters having the specific bond exist in the virtual cards, the obtaining operation on M virtual cards corresponding to the M virtual characters.

S1806: Remove the locked state of the specific bond, and remove the refresh-disabled state of the virtual card display window.

S1807: Obtain a refresh operation performed by the user account on the virtual card display window.

S1808: Refresh the virtual cards in the virtual card display window.

In this application, based on lock conditions set by the user account (for example, locking the first virtual character, locking the specific level of the first virtual character, and locking the first virtual character having the specific bond), whether a virtual card satisfying the lock conditions exists in the virtual card display window is determined, and if the virtual card satisfying the locking conditions exists, the virtual card display window is set to the refresh-disabled state, thereby resolving the problem of players accidentally skipping cards due to overly quick card refreshing. This resolves the problem of players potentially skipping cards due to quick card refreshing within a limited time, and provides a more precise card locking manner, making it convenient for players to lock virtual characters that satisfies corresponding conditions, thereby improving the gaming experience, and reducing the negative experience caused by accidental card skipping.

For the foregoing method embodiments, for brief description, all method embodiments are described as a series of action combinations. However, a person of ordinary skill in the art needs to note that this application is not limited by the described action sequence. Because in accordance with this application, operations may be performed in other orders or simultaneously. In addition, a person of ordinary skill in the art needs to note that embodiments described in the specification are all preferred embodiments, and the involved action and module are not necessarily required for this application.

According to another aspect of the embodiments of this application, an apparatus for obtaining a virtual character configured to implement the foregoing method for obtaining a virtual character is further provided. As shown in FIG. 19, the apparatus includes:
a response module 1902, configured to: set, in a preparation phase of a current game, in response to a lock operation on a first virtual character, a state of the first virtual character to a locked state, the first virtual character being a virtual character deployed by a user account in the current game; and
a display module 1904, configured to: display, when a virtual card display window is refreshed, a plurality of virtual cards in the virtual card display window, each virtual card corresponding to one virtual character, each of the plurality of virtual cards being configured for determining, when obtained by the user account, the corresponding virtual character as the virtual character deployed by the user account in the current game, if a first virtual card corresponding to the first virtual character that is in the locked state exists in the plurality of virtual cards, the virtual card display window being set to a refresh-disabled state, and the refresh-disabled state being configured for keeping the plurality of virtual cards displayed in the virtual card display window unchanged when the virtual card display window is refreshed.

In a possible implementation, the apparatus further includes a setting module 1906, as shown by a dashed box in FIG. 19. The setting module 1906 is configured to set the virtual card display window to the refresh-disabled state.

In an exemplary embodiment, the display module 1904 is configured to: if the first virtual card exists in the plurality of virtual cards, display the plurality of virtual cards in the virtual card display window, and display a lock icon on the first virtual card.

The apparatus is further configured to remove the locked state of the first virtual character in response to a trigger operation on the lock icon displayed on the first virtual card.

In an exemplary embodiment, the apparatus is further configured to: remove the locked state of the first virtual character in response to an obtaining operation on the first virtual card; and remove, when N first virtual cards exist in the virtual card display window, the locked state of the first virtual character in response to an obtaining operation on an N^{th} first virtual card, N being an integer greater than 1, and the N^{th} first virtual card being the last obtained virtual card of the N first virtual cards.

In an exemplary embodiment, the apparatus is further configured to: set, in the preparation phase of the current game, in response to a lock operation on a specific level of the first virtual character, the state of the first virtual character to the locked state if the first virtual character has not been merged into a virtual character of the specific level; and display the plurality of virtual cards in the virtual card display window when the virtual card display window is refreshed, the virtual card display window being set to the refresh-disabled state if the first virtual card exists in the plurality of virtual cards displayed in the virtual card display window.

In an exemplary embodiment, the apparatus is further configured to display the first virtual character in a preparation zone of the current game in response to the obtaining operation on the first virtual card, in a battle phase of the current game, the first virtual character in the preparation zone being allowed to be deployed by the user account in a battle zone to battle.

In an exemplary embodiment, the apparatus is further configured to: merge, if a quantity of first virtual characters deployed by the user account in the current game reaches a first preset quantity, the first preset quantity of first virtual characters into the virtual character of the specific level, a battle power of the virtual character of the specific level being greater than a battle power of the first virtual character, and the first virtual character deployed by the user account including the first virtual character deployed in the preparation zone and the first virtual character deployed in the battle zone; and remove the locked state of the first virtual character.

In an exemplary embodiment, the apparatus is further configured to: set, in the preparation phase of the current game, in response to a lock operation on a specific bond of the first virtual character, a state of the specific bond to the locked state, a first battle attribute corresponding to the specific bond being activated when a quantity of specific bonds deployed by the user account in the current game reaches a second preset quantity; and display the plurality of virtual cards in the virtual card display window when the virtual card display window is refreshed, each virtual card corresponding to one virtual character, each virtual character corresponding to one or more bonds, and if a virtual card corresponding to the virtual character having the specific bond exists in the plurality of virtual cards, the virtual card display window being set to the refresh-disabled state.

In an exemplary embodiment, the display module 1904 is configured to: if M virtual characters corresponding to M virtual cards of the plurality of virtual cards have the specific bond, display the plurality of virtual cards in the virtual card display window, and display lock icons on the M virtual cards, M being an integer greater than or equal to 1.

The apparatus is further configured to remove the locked state of the specific bond in response to the trigger operation on the lock icon displayed on any one of the M virtual cards.

In an exemplary embodiment, the apparatus is further configured to: remove, if a third virtual card corresponding to the virtual character having the specific bond exists in the virtual card display window, the locked state of the specific bond in response to an obtaining operation on the third virtual card; or remove, if K virtual characters corresponding to K virtual cards in the virtual card display window have the specific bond, the locked state of the specific bond in response to an obtaining operation on a K^{th} virtual card of the K virtual cards, the K^{th} virtual card being the last obtained virtual card of the K virtual cards.

In an exemplary embodiment, the apparatus is further configured to display a second virtual character in the preparation zone of the current game in response to an obtaining operation on a second virtual card of the plurality of virtual cards, the second virtual card being a virtual card corresponding to the second virtual character having the specific bond, and in a battle phase of the current game, the second virtual character in the preparation zone being allowed to be deployed by the user account in the battle zone to battle.

In an exemplary embodiment, the apparatus is further configured to: activate, if S virtual characters deployed in the battle zone by the user account in the current game have the specific bond and the quantity of specific bonds reaches the second preset quantity, the first battle attribute of the S virtual characters, S being an integer greater than or equal to 1.

According to an aspect of this application, a computer program product is provided. The computer program product includes a computer program, the computer program including program code for executing the method shown in the flowchart. In this embodiment, the computer program may be uploaded and installed from a network through a communication part 2009, and/or be installed from a removable media 2011. When the computer program is executed by a central processing unit 2001, various functions provided in the embodiments of this application are executed.

Sequence numbers of the foregoing embodiments of this application are merely for description, and do not indicate superiority or inferiority of the embodiments.

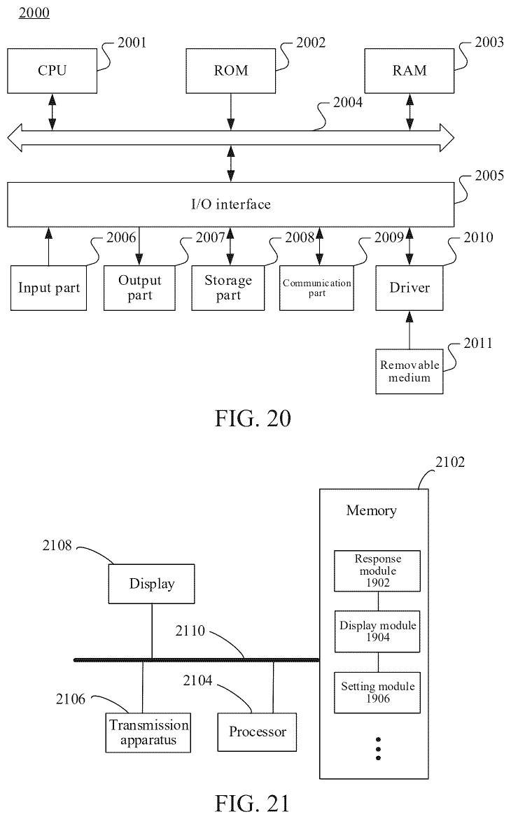

FIG. 20 is a structural block diagram of a computer system for implementing the electronic device according to an embodiment of this application.

A computer system 2000 of the electronic device shown in FIG. 20 is merely an example, and does not limit functions and the scope of usage of embodiments of this application.

As shown in FIG. 20, the computer system 2000 includes a central processing unit (CPU) 2001, and the central processing unit may perform various suitable actions and processes based on a program stored in a read-only memory (ROM) 2002 or a program loaded to a random access memory (RAM) 2003 from a storage part 2008. Various programs and data needed for a system operation are stored in the random access memory 2003. The central processing unit 2001, the read-only memory 2002, and the random access memory 2003 are connected to each other through a bus 2004. An input/output interface (I/O interface) 2005 is connected to the bus 2004.

The following components are connected to the input/output interface 2005: an input part 2006 including a keyboard, a mouse, and the like; an output part 2007, including a cathode ray tube (CRT), a liquid crystal display (LCD), a speaker, and the like; a storage part 2008 including a hard disk; and a communication part 2009 including a network interface card such as a local area network card or a modem. The communication part 2009 performs communication processing via a network such as the Internet. A driver 2010 is also connected to the input/output interface 2005 according to a requirement. A removable media 2011, such as a magnetic disk, an optical disk, a magneto-optical disk, a semiconductor memory, and the like are installed on the drive 2010 as needed, so that it may be read that a computer program is installed to the storage part 2008 as needed.

Specifically, based on the embodiments of this application, a process described foregoing with reference to the method flowchart may be implemented as a computer software program. For example, an embodiment of this application includes a computer program product, and the computer program product is carried on computer program of a computer-readable medium. The computer program includes a program code configured to perform the method shown in the flowchart. In this embodiment, the computer program may be uploaded and installed from the network through the communication part 2009, and/or be installed from the removable media 2011. When the computer program is executed by the central processing unit 2001, various functions limited in a system of this application are executed.

According to still another aspect of the embodiments of this application, an electronic device configured to implement the foregoing method for obtaining a virtual character is further provided. The electronic device may be the terminal device or the server shown in FIG. 1. This embodiment is described by using an example in which the electronic device is the terminal device. As shown in FIG. 21, the electronic device includes a memory 2102 and a processor 2104. The memory 2102 has a computer program stored therein, and the processor 2104 is configured to execute operations in any one of the foregoing method embodiments through the computer program.

In this embodiment, the electronic device may be located in at least one of a plurality of network devices of a computer network.

In some embodiments, a person of ordinary skill in the art may understand that the structure shown in FIG. 21 is merely an example, and the electronic device may also be a terminal device such as a smartphone (such as an Android phone or an iOS phone), a tablet computer, a palmtop computer, a mobile internet device (MID), or a PAD. FIG. 21 does not limit the structure of the foregoing electronic device. For example, the electronic device may further include more or fewer components (such as a network interface) than the components shown in FIG. 21, or have different configuration than the configuration shown in FIG. 21.

The memory 2102 may be configured to store a software program and a module, such as program instructions/modules corresponding to the method and apparatus for obtaining a virtual character in the embodiments of this application. The processor 2104 executes various functional applications and data processing by running the software program and the module stored in the memory 2102, that is, implements the foregoing method for obtaining a virtual character. The memory 2102 may include a high-speed random access memory, and may further include a nonvolatile memory, such as one or more magnetic disk storage apparatus, a flash memory, or another nonvolatile solid-state storage device. In some examples, the memory 2102 may further include a memory remotely disposed relative to the processor 2104, and these remote memories may be connected to the terminal through the network. Examples of the foregoing network include, but are not limited to, an internet, an intranet, a local area network, a mobile communication network, and a combination thereof. The memory 2102 may be specifically configured to, but is not limited to, store information such as user accounts, virtual characters, and virtual cards. For example, as shown in FIG. 21, the memory 2102 may include, but is not limited to, the response module 1902, the display module 1904, and the setting module 1906 of the foregoing apparatus for obtaining a virtual character. In addition, other module units of the foregoing apparatus for obtaining a virtual character may be further included but are not limited thereto. Details are not described herein again in this example.

In some embodiments, a transmission apparatus 2106 is configured to receive or send data through a network. Specific examples of the foregoing network may include a wired network and a wireless network. In an example, the transmission apparatus 2106 includes a network interface controller (NIC). The network interface controller may be connected to another network device and a router through a network line, to communicate with the internet or the local area network. In an example, the transmission apparatus 2106 is a radio frequency (RF) module, and is configured to communicate with the internet in a wireless manner.

In addition, the electronic device further includes a display 2108, configured to display a game picture in a current game; and a connection bus 2110, configured to connect various module components in the electronic device.

In another embodiment, the terminal device or the server may be a node in a distributed system. The distributed system may be a blockchain system, and the blockchain system may be a distributed system formed by connecting a plurality of nodes through a form of network communication. A peer-to-peer network may be formed between the nodes. Any form of computing device, for example, an electronic device such as the server or the terminal, may join the peer-to-peer network to become a node in the blockchain system.

According to an aspect of this application, a computer-readable storage medium is provided. A processor of a computer device reads the computer program from the computer-readable storage medium, and the processor executes the computer program, so that the computer device executes the method for obtaining a virtual character provided in the foregoing implementations.

In some embodiments, a person of ordinary skill in the art may understand that all or some of the operations to the embodiments may be by a program instructing relevant hardware of a terminal device. The program may be stored in using a computer-readable storage medium. The storage medium may include a flash disk, a read-only memory (ROM), a random access memory (RAM, magnetic disk, an optical disk, or the like.

Sequence numbers of the foregoing embodiments of this application are merely for description, and do not indicate superiority or inferiority of the embodiments.

When the integrated unit of the foregoing embodiments is implemented in the form of a software functional unit and sold or used as an independent product, the integrated unit may be stored in the foregoing computer-readable storage medium. Based on such an understanding, the technical solutions of this application essentially, or the part contributing to the related art, or all or a part of the technical solutions may be implemented in the form of a software product. The computer software product is stored in a storage medium and includes several instructions for instructing a computer device (which may be a personal computer, a server, or a network device) to perform all or some of the operations in the methods described in the embodiments of this application.

In the foregoing embodiments of this application, the descriptions of each embodiment have different focuses, and for a part that is not described in detail in an embodiment, reference may be made to the relevant descriptions of other embodiments.

In several embodiments provided in this application, a disclosed client may be implemented in other manners. For example, the described apparatus embodiment is merely an example. For example, the unit division is merely logical function division and may be other division during actual implementation. For example, a plurality of units or components may be merged or integrated into another system, or some features may be ignored or not performed. In addition, the displayed or discussed mutual couplings or direct couplings or communication connections may be implemented by some interfaces; indirect couplings or communication connections between units or modules which may be electric or in other forms.

The units described as separate components may or may not be physically separate, and components displayed as units may or may not be physical units, may be located in one place, or may be distributed on a plurality of network units. Some or all of the units may be selected based on actual requirements to implement the objectives of the solutions of this embodiment.

In addition, functional units in this embodiment of this application may be integrated into one processing unit, each of the units may exist alone physically, or two or more units are integrated into one unit. The integrated unit may be implemented in a form of hardware, or may be implemented in a form of a software functional unit.

The foregoing is merely a preferred implementation of the embodiments of this application. A person of ordinary skill in the art can further make several improvements and refinements without departing from the principle of this application, and the improvements and refinements a shall fall within the protection scope of this application.

What is claimed is:

1. A method for obtaining a virtual character in a game performed by an electronic device, the method comprising:
during a preparation phase of a current game, in response to a lock operation on a first virtual character deployed by a user account in the current game, setting a state of the first virtual character to a locked state;
when a virtual card display window of the current game is refreshed, displaying a plurality of virtual cards in the virtual card display window, each of the plurality of virtual cards being configured for determining, when obtained by the user account, a corresponding virtual character as the virtual character deployed by the user account in the current game; and
when a first virtual card corresponding to the first virtual character that is in the locked state exists in the plurality of virtual cards, setting the virtual card display window to a refresh-disabled state, and the refresh-disabled state being configured for keeping the plurality of virtual cards displayed in the virtual card display window unchanged when the virtual card display window is refreshed.

2. The method according to claim 1, wherein the displaying a plurality of virtual cards in the virtual card display window comprises:
when the first virtual card exists in the plurality of virtual cards, displaying a lock icon on the first virtual card; and
removing the locked state of the first virtual character in response to a trigger operation on the lock icon displayed on the first virtual card.

3. The method according to claim 1, further comprising:
removing the locked state of the first virtual character in response to an obtaining operation on the first virtual card; and
removing, when N first virtual cards exist in the virtual card display window, the locked state of the first virtual character in response to an obtaining operation on an N^{th} first virtual card, N being an integer greater than 1, and the N^{th} first virtual card being the last obtained virtual card of the N first virtual cards.

4. The method according to claim 1, further comprising:
in response to a lock operation on a specific level of the first virtual character, setting the state of the first virtual character to the locked state when the first virtual character has not been merged into a virtual character of the specific level;
displaying the plurality of virtual cards in the virtual card display window when the virtual card display window is refreshed; and
setting the virtual card display window to the refresh-disabled state when the first virtual card exists in the plurality of virtual cards displayed in the virtual card display window.

5. The method according to claim 4, further comprising:
displaying the first virtual character in a preparation zone of the current game in response to the obtaining operation on the first virtual card, wherein the first virtual character in the preparation zone is allowed to be deployed by the user account in a battle zone of the current game.

6. The method according to claim 1, further comprising:
during the preparation phase of the current game, in response to a lock operation on a specific bond of the first virtual character, setting a state of the specific bond to the locked state, a first battle attribute corresponding to the specific bond being activated when a quantity of specific bonds deployed by the user account in the current game reaches a second preset quantity; and
displaying the plurality of virtual cards in the virtual card display window when the virtual card display window is refreshed, each virtual card corresponding to one virtual character, each virtual character corresponding to one or more bonds; and
when a virtual card corresponding to the virtual character having the specific bond exists in the plurality of virtual cards, setting the virtual card display window to the refresh-disabled state.

7. The method according to claim 6, wherein the displaying a plurality of virtual cards in the virtual card display window comprises:
when M virtual characters corresponding to M virtual cards of the plurality of virtual cards have the specific bond, displaying the plurality of virtual cards in the virtual card display window, and displaying lock icons on the M virtual cards, M being an integer greater than or equal to 1; and
removing the locked state of the specific bond in response to the trigger operation on the lock icon displayed on any one of the M virtual cards.

8. An electronic device, comprising a memory and a processor, the memory having a computer program stored therein, the computer program, when executed by the processor, causing the electronic device to perform a method for obtaining a virtual character in a game including:
during a preparation phase of a current game, in response to a lock operation on a first virtual character deployed by a user account in the current game, setting a state of the first virtual character to a locked state;
when a virtual card display window of the current game is refreshed, displaying a plurality of virtual cards in the virtual card display window, each of the plurality of virtual cards being configured for determining, when obtained by the user account, a corresponding virtual character as the virtual character deployed by the user account in the current game; and
when a first virtual card corresponding to the first virtual character that is in the locked state exists in the plurality of virtual cards, setting the virtual card display window to a refresh-disabled state, and the refresh-disabled state being configured for keeping the plurality of virtual cards displayed in the virtual card display window unchanged when the virtual card display window is refreshed.

9. The electronic device according to claim 8, wherein the displaying a plurality of virtual cards in the virtual card display window comprises:
when the first virtual card exists in the plurality of virtual cards, displaying a lock icon on the first virtual card; and
removing the locked state of the first virtual character in response to a trigger operation on the lock icon displayed on the first virtual card.

10. The electronic device according to claim 8, wherein the method further comprises:
removing the locked state of the first virtual character in response to an obtaining operation on the first virtual card; and
removing, when N first virtual cards exist in the virtual card display window, the locked state of the first virtual character in response to an obtaining operation on an N^{th} first virtual card, N being an integer greater than 1, and the N^{th} first virtual card being the last obtained virtual card of the N first virtual cards.

11. The electronic device according to claim 8, wherein the method further comprises:
in response to a lock operation on a specific level of the first virtual character, setting the state of the first virtual character to the locked state when the first virtual character has not been merged into a virtual character of the specific level;
displaying the plurality of virtual cards in the virtual card display window when the virtual card display window is refreshed; and
setting the virtual card display window to the refresh-disabled state when the first virtual card exists in the plurality of virtual cards displayed in the virtual card display window.

12. The electronic device according to claim 11, wherein the method further comprises:
displaying the first virtual character in a preparation zone of the current game in response to the obtaining operation on the first virtual card, wherein the first virtual character in the preparation zone is allowed to be deployed by the user account in a battle zone of the current game.

13. The electronic device according to claim 8, wherein the method further comprises:
during the preparation phase of the current game, in response to a lock operation on a specific bond of the first virtual character, setting a state of the specific bond to the locked state, a first battle attribute corresponding to the specific bond being activated when a quantity of specific bonds deployed by the user account in the current game reaches a second preset quantity; and
displaying the plurality of virtual cards in the virtual card display window when the virtual card display window is refreshed, each virtual card corresponding to one virtual character, each virtual character corresponding to one or more bonds; and
when a virtual card corresponding to the virtual character having the specific bond exists in the plurality of virtual cards, setting the virtual card display window to the refresh-disabled state.

14. The electronic device according to claim 13, wherein the displaying a plurality of virtual cards in the virtual card display window comprises:
when M virtual characters corresponding to M virtual cards of the plurality of virtual cards have the specific bond, displaying the plurality of virtual cards in the virtual card display window, and displaying lock icons on the M virtual cards, M being an integer greater than or equal to 1; and
removing the locked state of the specific bond in response to the trigger operation on the lock icon displayed on any one of the M virtual cards.

15. A non-transitory computer-readable storage medium, comprising a stored computer program, the computer program, when executed by a processor of a computer device, causing the computer device to perform a method for obtaining a virtual character in a game including:
during a preparation phase of a current game, in response to a lock operation on a first virtual character deployed by a user account in the current game, setting a state of the first virtual character to a locked state;
when a virtual card display window of the current game is refreshed, displaying a plurality of virtual cards in the virtual card display window, each of the plurality of virtual cards being configured for determining, when obtained by the user account, a corresponding virtual character as the virtual character deployed by the user account in the current game; and
when a first virtual card corresponding to the first virtual character that is in the locked state exists in the plurality of virtual cards, setting the virtual card display window to a refresh-disabled state, and the refresh-disabled state being configured for keeping the plurality of virtual cards displayed in the virtual card display window unchanged when the virtual card display window is refreshed.

16. The non-transitory computer-readable storage medium according to claim 15, wherein the displaying a plurality of virtual cards in the virtual card display window comprises:
when the first virtual card exists in the plurality of virtual cards, displaying a lock icon on the first virtual card; and
removing the locked state of the first virtual character in response to a trigger operation on the lock icon displayed on the first virtual card.

17. The non-transitory computer-readable storage medium according to claim 15, wherein the method further comprises:
removing the locked state of the first virtual character in response to an obtaining operation on the first virtual card; and
removing, when N first virtual cards exist in the virtual card display window, the locked state of the first virtual character in response to an obtaining operation on an N^{th} first virtual card, N being an integer greater than 1, and the N^{th} first virtual card being the last obtained virtual card of the N first virtual cards.

18. The non-transitory computer-readable storage medium according to claim 15, wherein the method further comprises:
in response to a lock operation on a specific level of the first virtual character, setting the state of the first virtual character to the locked state when the first virtual character has not been merged into a virtual character of the specific level;
displaying the plurality of virtual cards in the virtual card display window when the virtual card display window is refreshed; and
setting the virtual card display window to the refresh-disabled state when the first virtual card exists in the plurality of virtual cards displayed in the virtual card display window.

19. The non-transitory computer-readable storage medium according to claim 15, wherein the method further comprises:
during the preparation phase of the current game, in response to a lock operation on a specific bond of the first virtual character, setting a state of the specific bond to the locked state, a first battle attribute corresponding to the specific bond being activated when a quantity of specific bonds deployed by the user account in the current game reaches a second preset quantity; and
displaying the plurality of virtual cards in the virtual card display window when the virtual card display window is refreshed, each virtual card corresponding to one virtual character, each virtual character corresponding to one or more bonds; and
when a virtual card corresponding to the virtual character having the specific bond exists in the plurality of virtual cards, setting the virtual card display window to the refresh-disabled state.

20. The non-transitory computer-readable storage medium according to claim 19, wherein the displaying a plurality of virtual cards in the virtual card display window comprises:
when M virtual characters corresponding to M virtual cards of the plurality of virtual cards have the specific bond, displaying the plurality of virtual cards in the virtual card display window, and displaying lock icons on the M virtual cards, M being an integer greater than or equal to 1; and
removing the locked state of the specific bond in response to the trigger operation on the lock icon displayed on any one of the M virtual cards.
